(19) United States
(12) Patent Application Publication
(10) Pub. No.: US 2015/0145229 A1
(43) Pub. Date: May 28, 2015

(54) Removable spindle assembly for torsion axles

(71) Applicants: William Dunlap, Elkhart, IN (US); James C. Tuthill, Elkhart, IN (US)

(72) Inventors: William Dunlap, Elkhart, IN (US); James C. Tuthill, Elkhart, IN (US)

(21) Appl. No.: 13/998,714

(22) Filed: Nov. 26, 2013

(51) Int. Cl. B60B 35/00; B60B 35/02

(52) U.S. Cl. CPC B60B 35/004; B60B 35/02
USPC 280/124.125

(57) ABSTRACT

A torsion axle arrangement is provided wherein the spindle is mounted to the suspension link by a keyed connection facilitated with a selectively orientable disc then fixed to the suspension link according to a given application. That connection is maintained by a bolt passing through the suspension link and engaging a mating groove in the spindle. The bolt is anchored within the suspension link by a threaded connection internal to the suspension link. The shape of the key can be selected as desired for immediate source identification.

### RELATED PATENT

This application is a continuation in part of U.S. patent application Ser. No. 29/424,009, filed Jun. 7, 2012, and issued as U.S. Pat. No. D694,158, on Nov. 26, 2013.

### BACKGROUND OF THE INVENTION

Torsion axles arrangements are commonly used in vehicles of various types, including cargo trailers, recreational travel trailers, and boat trailers. These arrangements generally include an axle element (which is mounted transversely across a portion of the vehicle frame, usually from one side to the other), a suspension link element (which is mounted to the axle, usually at both ends thereof, and generally extends perpendicularly or radially outward from the axle length), and a spindle element (which is attached to the suspension link). The brakes and/or wheels of the vehicle are mounted on the spindle elements. The nature of the torsion axle is such that the suspension link allows the spindle and its associated wheels, etc., to move vertically with respect to the vehicle as the vehicle encounters various road conditions and/or the vehicle is subject to different loads. This occurs because a free end of the suspension link is movable, usually rotatably, with respect to the axle. As a result, the torsion axle arrangement can serve to absorb road stress forces which would otherwise be transferred directly to the vehicle and its contents.

To optimize performance and service life, brakes and wheels are typically mounted on the spindles so as to have a particular orientation when the vehicle is under its normal load. For example, particular radial orientations of brakes give better performance and useful life to those components. In certain hydraulic brakes, it has, for example, been found to be advisable to keep the bleeder opening at or near the top of the brake so that air does not become trapped in the hydraulic fluid. Similarly, with certain electrical brakes, it has, for example, been found to be advisable for the magnet to be at the bottom so that occasional bumps in the road do not accidentally actuate the brake. Also, spindles and/or components attached thereto typically include internal lubrication features. It has been found that ports for lubrication flow benefit from having a neutral axis so as to avoid stress concentrations.

In order to reduce manufacturing costs, it has been found advisable to use a common type of torsion axle arrangement for vehicles having several different expected loads. This is often accommodated at the factory by having the suspension link mounted or attached at various selected angles with respect to the normal or expected horizontal position of the axle element when the axle element is mounted on the vehicle. When the axle arrangement is later mounted to the vehicle and under normal load, the link is then rotated upward (or down, depending upon the application or use) by the forces (usually vehicle weight) applied to it, to rest at its normal “height,” giving sufficient wheel-to-vehicle clearance for normal use. Alternatively (or sometimes in addition), the same type of torsion axle arrangement is used to give various different axle heights or clearance above the road surface, again by varying the angle of the suspension link with respect to the normal horizontal orientation of the axle element.

To accommodate both the desired radial orientation of the wheels and/or brakes, and/or of the lubrication features, and the selected angle which the suspension link is attached to the axle element, spindles can be attached to the suspension link in a variety of radial positions, ranging, for example, from 45 degrees down to 22 degrees up. These radial positions are selected such that during normal load and/or operation of the vehicle (when vehicle weight or load forces the suspension link to rotate about the horizontal axis of the axle element), the brake is upright and the lubrication openings are on a neutral axis, even though the brakes may be in an angled position and the lubrication openings at some other axis when the torsion axle arrangement is assembled at the factory.

Unfortunately, road stresses over an extended time, unusually high loads, “shock loads,” vehicle accidents, and the like can cause the spindle and/or related components to fail even though the suspension link and/or axle element remain in working order. In some prior arrangements, the spindle assembly could not be effectively repaired in the field since it was necessary as a practical matter to remove the entire torsion axle arrangement from the vehicle in order to make the needed repairs or replacement of components. In certain prior arrangements, the spindle was removably attached to the suspension link, such as by use of a tapered socket opening in the suspension link for mating with a tapered end of the spindle, and then a draw nut assembly was applied to that tapered end once so mated. However, that arrangement was not always field serviceable since sufficient access to the draw nut may be highly constrained in a given application or environment of use, and the draw nut is exposed to corrosion.

It has been suggested to instead create a removable spindle with a split socket design at one end of the suspension link in order to receive the spindle, and to then clamp the spindle in place with compression of exterior, mating tabs or ears extending from the free end of the suspension link, by a substantially vertical nut and bolt connection. A snap ring could then be used as the “fail safe” on the back end of the spindle, instead of the draw washer or retaining ring/disc. That arrangement can in certain applications and situations provide the advantage of greater access to the nut and bolt connection for field servicing. However, if when remounting, the nut and bolt orientation is reversed, there is no means of bolt retention when the nut works loose in use. Thus, to be reliable, the snap ring must be a significant structure. Also, both the snap ring and the nut and bolt connection are still exposed to corrosion.

Further, when mounting the new spindle, both of those prior arrangements rely upon the field installer (sometimes an end user doing his own repair work) to provide the correct brake and lubrication port orientations. In certain field situations, and with a wide range of field installer skill, getting those orientations correct can be difficult.

Another consideration is that vehicle manufacturers may not always purchase torsion axle arrangements from the same manufacturers even within production of a given model of vehicle. Since torsion axle arrangements are typically mounted underneath a vehicle and/or are largely concealed during use, it is not always readily perceived by the end user and/or field installer which type or brand of torsion axle is needed for a given repair. Stampings or brand marks on the axle or its elements may be covered with grease, mud, debris, etc., or worn off due to the environment and nature of vehicle use. Spindles of each manufacturer may be similar in size and dimension, but not sufficiently identical to allow safe and reliable substitution. Thus, it can be important for a field installer to readily and accurately determine which brand and/or model of spindle is needed in a given instance.

Accordingly, it is an object of the present invention to provide an improved torsion axle arrangement. More specifically, the present invention is intended to provide torsion axle arrangements which:
a. are relatively inexpensive to manufacture and reliable in use,
b. facilitate reduced inventory costs to vehicle manufacturers and aftermarket parts suppliers for field installers,
c. are easy and relatively inexpensive to repair in the field,
d. resist corrosion effects,
e. provide reliable replication of factory settings in the field,
f. permit easier spindle installation and replacement,
g. can be repaired without special tools, and
h. facilitate ready recognition of the product source.

### SUMMARY OF THE INVENTION

These and other objects of the present invention are obtained by the provision of a torsion axle arrangement wherein the spindle is mounted to the suspension link by a keyed connection facilitated with a selectively orientable disc then fixed to the suspension link according to a given application. That connection is maintained by a bolt passing through the suspension link and engaging a mating groove in the spindle. The bolt is anchored within the suspension link by a threaded connection internal to the suspension link. The shape of the key can be selected as desired for immediate source identification.

Other objects, advantages, and novel features of the present invention will become more readily apparent from the following drawings and detailed description of preferred embodiments of this invention.

### BRIEF DESCRIPTION OF THE DRAWINGS:

FIG. 1 shows a front view of a preferred embodiment of a suspension link according to the present invention.

FIG. 2 shows back view of the embodiment of FIG. 1.

FIG. 3 shows a left side view of the embodiment of FIG. 1.

FIG. 4 shows a right side view of the embodiment of FIG. 1.

FIG. 5 shows forward or upper end view of the embodiment of FIG. 1.

FIG. 6 shows a rear or lower end view of the embodiment of FIG. 1.

FIG. 7 shows a front, right, forward perspective view of the embodiment of FIG. 1.

FIG. 8 shows an exploded view of a torsion axle arrangement according to the present invention from the front, left, forward perspective view.

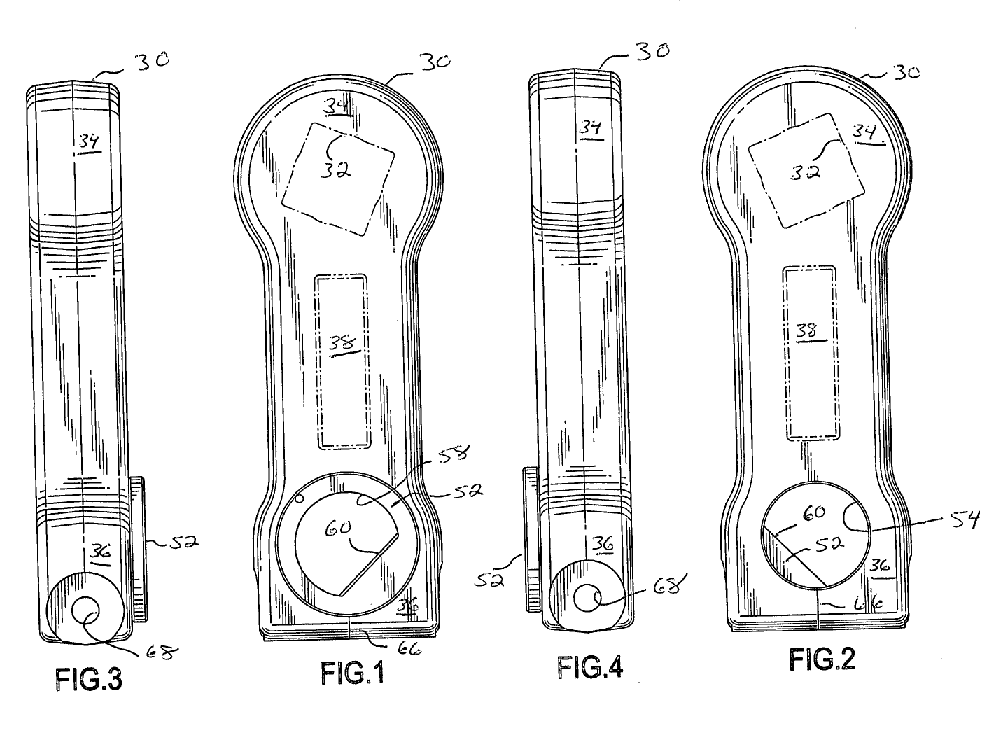

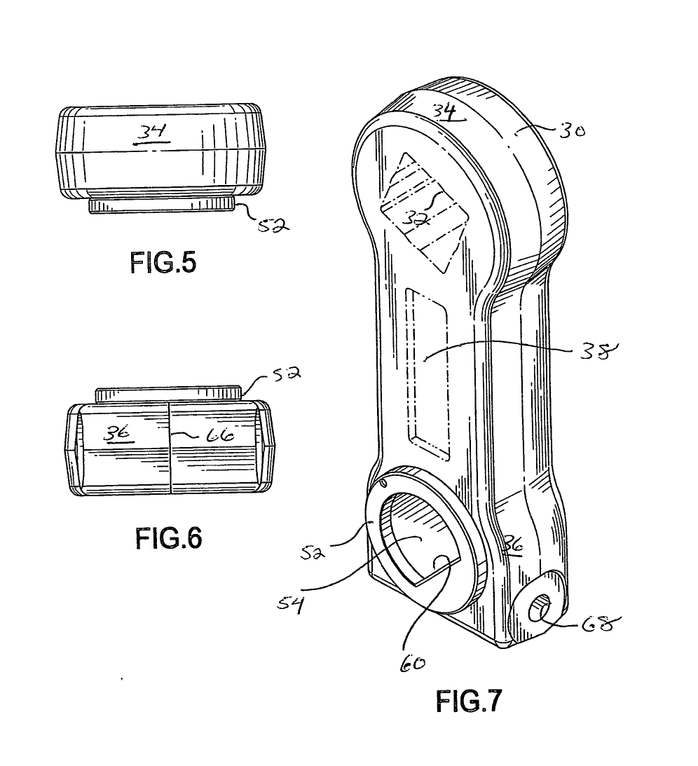

### DETAILED DESCRIPTION OF PREFERRED EMBODIMENTS

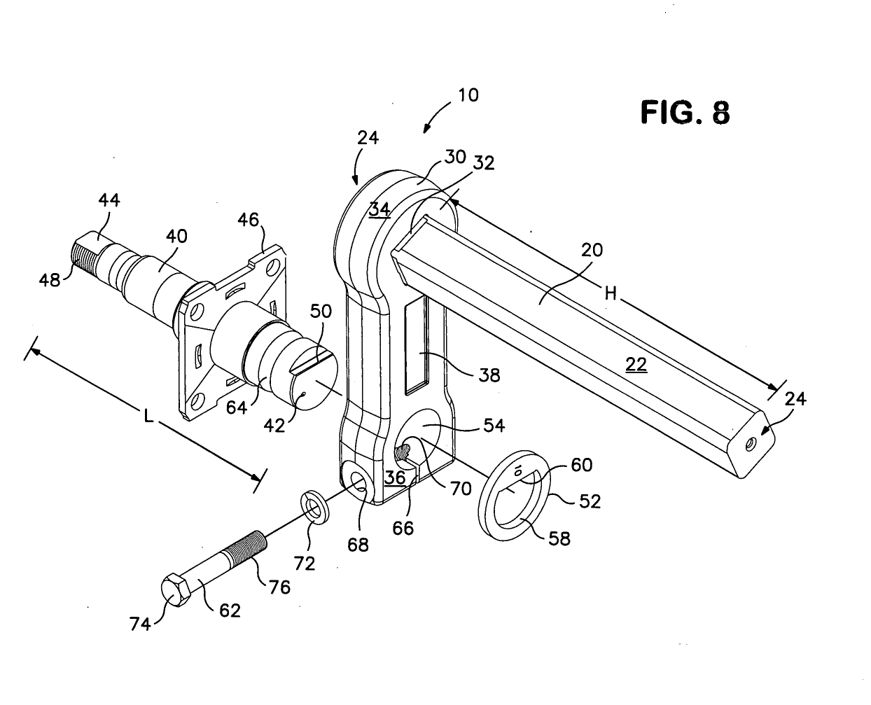

FIG. 8 shows a preferred embodiment of a torsion axle arrangement 10 which incorporates the teachings of the present invention. As shown in that drawing, arrangement 10 includes axle element 20, suspension link 30, and spindle element 40. Axle 20 has a significant horizontal length H and is, for example, of conventional construction. Axle 20 can include a flat surface 22 in certain application which facilitates both manufacture and aligned fitting onto a vehicular frame. Axle 20 is typically connected to a suspension link 30 at each end 24 of its horizontal length, although for the ease of understanding, only one such suspension link is shown in FIG. 8. That connection often involves an end 24 passing into and through an opening 32 in suspension link 30.

Suspension link 30 has two ends, a forward end 34 and a rear end 36. The connection of axle 20 to suspension link 30 and the structure of forward end 34 is, for example, conventional in nature, in the embodiment shown in FIG. 8. For purposes of implementing the present invention, a variety of forward end structures and/or axle connections can be used. Suspension link 30 can also include brand and/or model designations 38 thereon by casting, stamping, labels, etc.

The present invention is shown in FIG. 8 to be involved with rear end 36, and will be described herein accordingly. However, it should be recognized that the present invention can be located elsewhere on suspension link 30, as appropriate for a given application. Also, the designations “forward” and “rear” are intended to be merely points of reference, not necessarily corresponding with orientation or direction of travel of the vehicle when the present invention is mounted thereto.

Spindle 40 is, for example, a generally elongated structure having a length L between an engaged end 42 and a free end 44. As desired for a given application, a connection plate 46 can be mounted on spindle 40 to support, orient, and/or locate brake assemblies and the like in a conventional or special manner, as desired for any particular application. Alternatively, plate 46 or its functional equivalent can be mounted on or integrally formed with suspension link 30. Spindle 40 is formed to support thereon wheels upon which the vehicle rides. Those wheels can be of a conventional or special nature, as desired for any particular application. Free end 44 of spindle 40 can be formed with a threaded portion 48 to facilitate retention of the wheels to spindle 40 or to assist with any conventional or desired end structure used in a given application. Spindle 40 can also include an internal lubrication system of a conventional or special nature, as desired for any particular application. Spindle 40 can further include conventional or special portions thereof which are rotatable in connection with wheel rotation, as desired in a given application.

Spindle 40 and suspension link 30 are formed to allow spindle 40 to be insertable into and removable from suspension link 30 in the field, as well as to be insertable into and removable from suspension link 30 in the factory. This is accomplished by the use of a keyed connection between those two elements. As shown in FIG. 8, the keyed connection includes a notch, cut-out, or flattened portion 50, adjacent engaged end 42 of spindle 40. The keyed connection also includes a selectively orientable disc 52 which is mounted in a fixed manner to suspension link 30, adjacent an opening 54 in rear end 36, into which engaged end 42 is inserted. Disc 52 includes a passageway 58 therethrough which, preferably, sufficiently corresponds with opening 54 in its dimensions such that at least a portion of engaged end 42 can enter opening 58 at the same time that spindle 40 is within opening 54. A flattened, shaped, or keyed surface or projection 60 is provided in opening 58 which sufficiently corresponds to the configuration of portion 50 that portion 50 is matingly received therein when spindle 40 is fully mounted into suspension link 30. That mating reception of portion 50 and projection 60 serves, for example, to positively locate spindle 40 with respect to suspension link 30 and prevent rotation of engaged end 42 within opening 54.

Disc 52 can be fixed to suspension link 30 by welding or such other conventional means, as is appropriate in a given application. Disc 52 can be mounted to the front side of suspension link 30, as shown in the drawings, or to the back side, according to where and to what extent along spindle 40 that portion 50 is formed. In embodiments of the present invention where a split collar structure (such as described further below) is employed at rear end 36 of suspension link 30, in certain applications it may also be advantageous to mount disc 52 intermediate the front and back sides of suspension link 30, such as along the length of opening 54. An important characteristic of disc 52 is that its configuration and location allow portion 50 of spindle 40 to be keyed to it when spindle 40 is in the “correct” or desired position with respect to suspension link 30.

Disc 52 is preferably fixed to suspension link 30 such that the brake and/or lubrication system and/or other features associated with spindle 40 will be in the desired position when the torsion axle arrangement sustains its normal load, due to the keyed connection with portion 50. In other words, the keying causes projection 60 to orient portion 50 which orients spindle 40 to suspension link 30 such that when the suspension link rotates about axle 20 as load is applied, the brakes, etc. end up in the desired orientation during normal vehicle use. Thus, during manufacturing, disc 52 can be merely rotated to predetermined angular positions about opening 54, and then welded in place. Thereafter, insertion of spindle 40 into suspension link 30 is automatically aligned as desired for a given load and/or vehicle height about the road surface.

Engaged end 42 is illustrated as having a generally circular cross-section, and opening 54 is illustrated as having a corresponding circular cross-section. However, since in certain applications rotation of spindle 40 within suspension link 30 may not be desirable, that cross-section is not required by the present invention. However, in other applications, such as where component commonality is desired for ease of manufacturing, such rotatability of spindle 40 at least during initial placement into suspension link 30 may be desired, and, accordingly, the circular cross-section can be advantageous. Similarly, the present invention allows the same spindle configuration to be used in left and right hand suspension link connections, thus further reducing the specialized inventory needs.

Projection 60 and portion 50 are illustrated as being keyed along a simple, flat length or surface. However, a number of other configurations for the keyed surface/connection are available and suitable for use with the present invention. For example, a chiseled tooth pattern, saw tooth pattern, or oblong curve could instead be formed in the side of engaged end 42, and then a corresponding cut made for projection 60. Given this variability, where disc 52 is mounted to an exposed portion of suspension link 30, the combination of the circumferential shape of that disc, the shape of projection 60, and the shape of passageway 58 provide ample opportunity for the manufacturer to create a readily visible and distinctive source-identifying brand or model designation. For example, in the illustrated embodiments, disc 52 is formed to present an opening therein which resembles a capital D, the trademark brand of Dexter Axle Company (the assignee of the present invention). In other embodiments, disc 52 could easily be formed to present an opening which resembles a capital B, or E, or an triangle, or square. Alternatively, disc 52 could provide the branding function by the shape of its exterior circumference.

The keyed connection between projection 60 and portion 50 is maintained in the present invention by an interference fit of bolt or fastener 62 passing through a portion of suspension link 30 and engaging a groove or notch 64 in spindle 40. In the illustrated embodiment, groove 64 is formed circumferentially about spindle 40 so as to facilitate the use of one spindle in multiple applications and/or to facilitate manufacturing. In other embodiments, the present invention envisions a less extensive notch for that purpose. Also, in the illustrated embodiment, rear end 36 is formed as a split collar 66 so as to facilitate insertion and removal of spindle 40 into and out of suspension link 30. However, in applications where especially close fit between those components is not required, that split is not needed. In the illustrated embodiment, bolt 62 passes through an opening or passageway 68 in the left side of rear end 36. That opening is not, for example, threaded at the outset. When bolt 62 is further inserted past the actual point of separation between split collar 66 (and past the point of initial engagement with groove 64), it enters, for example, a threaded portion 70 of opening 68. Tightening bolt 62 into that threaded portion will draw or clamp the arms of split collar 66 together in a conventional manner, and clamp spindle 40 into opening 54. Conventional lock washer 72 can be used to secure that fastening so that bolt 62 resists loosening or unthreading during normal vehicle use. Opening 68 can, in certain applications, pass completely through rear end 36 to the right side of suspension link 30, as illustrated, so as to void trapping debris in the opening and allow cleaning of threaded portion 70.

In especially preferred embodiments, opening 68 is formed such that during normal use of the vehicle, the head 74 of bolt 62 rests on a top or upper surface of suspension link 30, with bolt 62 extending vertically downward into rear end 36. (It should be noted that in actual use on a vehicle, the orientation of torsion axle arrangement 10 shown in FIG. 8 would be rotated clockwise about 90 degrees from what is shown). Thus, even if, somehow, bolt 62 works itself loose and unthreaded, the effect of gravity on bolt 62 and the length of the unthreaded portion of opening 68 tend to keep bolt 62 within opening 68 and in engagement with enough of notch 64 that spindle 40 cannot be removed from opening 54 and separated from the suspension link. Further, by threading only a portion of opening 68 at the opposite side of opening 68 (the lowermost portion, for example) from where bolt 62 is to be inserted, an installer of spindle 40 even in the field is forced to orient bolt 62 correctly. If the installer attempts to insert the bolt from the wrong end of opening 68, the limited threading on bolt 62, only at end portion 76, will not permit the bolt to completely enter opening 68. Thus, the installer will have immediate visual indicia of an erroneous mounting attempt.

Using an internal threading arrangement for bolt 62 tends to protect the bolt and its associated threading from corrosion during vehicle use. Further protection can be obtained by the use of a sealing cap on the lower end of opening 68, on the right side of suspension link 30 or, alternatively, by not forming that opening completely through rear end 36. Further, using an internal threading arrangement for bolt 62 can allow a manufacturer to avoid concern over having limited in field access to the nut fastener of the bolt since only one element needs to be manipulated by the installer's tool, bolt head 74.

Although the present invention has been described and illustrated above with respect to particular embodiments, it will be readily understood that many variations of embodiments are contemplated by this invention which have not been enumerated herein. Accordingly, the spirit and scope of the present invention are limited only by the terms of the following claims which define the invention.

What is claimed is:

1. A torsion axle arrangement comprising:
a suspension link,
a spindle for connection to the suspension link,
a first portion formed on the spindle,
a second portion formed to be fixed to the suspension link,
the first and second portions are in engagement when the spindle is fully connected to the suspension link, and
the first and second portions have a keyed configuration with respect to each other such that, when the spindle is connected to the suspension link, the keyed configuration requires the spindle to maintain a predetermined orientation with respect to the suspension link.

2. The torsion axle arrangement according to claim 1 further comprising:
the suspension link has an opening therein for receiving at least a portion of the spindle,
the spindle has a notched portion therein which is received with the opening when the spindle is fully connected to the suspension link,
the suspension link has a passageway leading to the notched portion, and
a fastener is provided which is inserted into the passageway and into engagement with the notched portion to prevent removal of the spindle from the opening.

3. The torsion axle arrangement according to claim 2 further comprising:
the opening of the suspension link includes a split collar which is clamped into closed positions by the fastener to assert engagement force to the spindle when the spindle is inserted into the opening, that engagement force tending to resist removal of the spindle from the opening.

4. The torsion axle arrangement according to claim 1 further comprising:
the suspension link has a first opening therein for receiving at least a portion of the spindle,
the second portion is formed as a separate element from the suspension link which is attached to the suspension link prior to insertion of the spindle into the first opening, and
the second portion includes a second opening therein for receiving at least a portion of the spindle and for receiving the first portion.

5. The torsion axle arrangement according to claim 4 further comprising:
the spindle has a notched portion therein which is received with the first opening when the spindle is fully connected to the suspension link,
the suspension link has a passageway leading to the notched portion, and
a removable fastener is provided which is inserted into the passageway and into engagement with the notched portion to prevent removal of the spindle from the first opening.

6. The torsion axle arrangement according to claim 5 further comprising:
an axle element attached to the suspension link, the suspension link forming a cantilevered connection to the axle by that attachment,
a vehicle frame attached to the axle element, and
vehicle wheels and a brake assembly attached to the spindle,

7. The torsion axle arrangement according to claim 6 further comprising:
the separate element is attached to the exterior of the suspension link and forms a visually distinctive indicia when so attached to the suspension link.

8. The torsion axle arrangement according to claim 6 wherein:
the suspension link is movable with respect to the axle element.
